(19) United States
(12) Patent Application Publication
(10) Pub. No.: US 2004/0117423 A1
(43) Pub. Date: Jun. 17, 2004

(54) Signed integer long division apparatus and methods for use with processors

(76) Inventors: Xiaohua Shi, Beijing (CN); Zhiwei Ying, Beijing (CN)

Correspondence Address: GROSSMAN & FLIGHT LLC, Suite 4220, 20 North Wacker Drive, Chicago, IL, 60606-6357, US

(21) Appl. No.: 10/316,708

(22) Filed: Dec. 11, 2002

(51) Int. Cl. G06F 7/52

(52) U.S. Cl. 708/650

(57) ABSTRACT

Methods and apparatus for performing a long division within a processor system are disclosed. The methods and apparatus include a memory and instructions stored in the memory to be executed by the processor system. When executed, the instructions cause the processor system to calculate a first value associated with an absolute value of a dividend and to multiply the first value by a second value to generate a third value. The second value is an absolute value of a fourth value associated with a reciprocal of a divisor. The processor system calculates a quotient based on the third value.

### FIELD OF THE DISCLOSURE

The present disclosure relates generally to processors and, more particularly, to signed integer long division apparatus and methods for use with processors.

### BACKGROUND

Many software applications such as, for example, Java applications and benchmarks such as, for example, Java Business Benchmark 2000 (JBB2000), require the processor executing the application or benchmark to perform long division of signed sixty-four bit integers. However, many existing thirty-two bit processors such as, for example, the Intel processor families collectively referred to as IA-32 processors, do not provide an instruction for performing a sixty-four bit signed integer division.

For thirty-two bit processors that do not provide an instruction for performing sixty-four bit signed integer divisions, software designers typically create an algorithm based on available thirty-two bit division instructions that can be executed by a thirty-two bit processor to perform the sixty-four bit division. For example, in the case of an IA-32 processor, a software designer may use an “idiv” instruction to generate an appropriate algorithm. Typically, the use of an algorithm based on thirty-two bit instructions to perform the sixty-four bit division operation results in a substantial amount of processing overhead (i.e., a relatively large number of processor operations and clock cycles for the operation being performed). Moreover, the substantial amount of processing overhead incurred by a processor executing an algorithm based on thirty-two bit instructions to carry out sixty-four bit operations and, in particular, using thirty-two bit division instructions to carry out a sixty-four bit signed integer division operation, can substantially reduce the effective throughput of a processor. Furthermore, the substantial processing overhead incurred by a thirty-two bit processor that is executing an algorithm based on thirty-two bit instructions to perform sixty-four bit divisions is compounded by the fact that many software applications (e.g., Java applications) require a relatively large number of sixty-four bit divisions.

To reduce processing overhead in a case where the value of a divisor is known during compilation time (i.e., prior to run-time) or is invariant (i.e., does not change) during run-time, some researchers have proposed the use of techniques that calculate the reciprocal of a divisor prior to run-time and then multiply the dividend by the reciprocal of the divisor during runtime to generate the quotient. In this manner, long division of two integer values, where the divisor is predetermined prior to run-time or that is invariant during run-time, can be carried out by a processor using only multiplication operations, thereby reducing the amount of time required to carry out the long division operation. Unfortunately, these proposed techniques typically require a substantial amount of processor memory (e.g., on-chip registers) and a substantial number of conditional jumps and load and store operations, all of which significantly reduce the effective run-time execution speed of long division operations as well as the effective throughput of the processor.

### BRIEF DESCRIPTION OF THE DRAWINGS

FIG. 1 is a block diagram of an example processor system that uses the signed integer long division apparatus and methods described herein;

FIG. 2 is an example flow diagram that illustrates one known manner in which a signed integer long division can be carried out by the processor system shown in FIG. 1; and

FIG. 3 is an example flow diagram that illustrates another manner in which a signed integer long division can be carried out by the processor system shown in FIG. 1.

### DETAILED DESCRIPTION

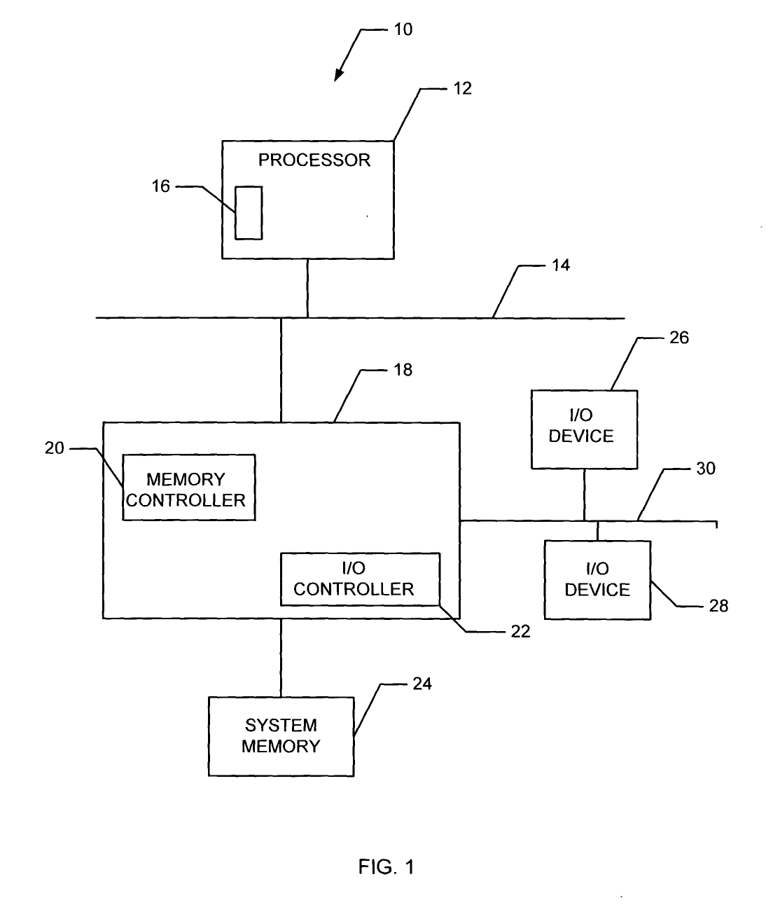

FIG. 1 is a block diagram of an example processor system 10 that uses the apparatus and methods described herein. As shown in FIG. 1, the processor system 10 includes a processor 12 that is coupled to an interconnection bus or network 14. The processor 12 includes a register set or register space 16, which is depicted in FIG. 1 as being entirely on-chip, but which could alternatively be located entirely or partially off-chip and directly coupled to the processor 12 via dedicated electrical connections and/or via the interconnection network or bus 14. The processor 12 may be any suitable processor, processing unit or microprocessor such as, for example, a processor from the Intel X-Scale™ family, the Intel Pentium™ family, etc. In the example described in detail below, the processor 12 is a thirty-two bit Intel processor, which is commonly referred to as an IA-32 processor. Although not shown in FIG. 1, the system 10 may be a multi-processor system and, thus, may include one or more additional processors that are identical or similar to the processor 12 and which are coupled to the interconnection bus or network 14.

The processor 12 of FIG. 1 is coupled to a chipset 18, which includes a memory controller 20 and an input/output (I/O) controller 22. As is well known, a chipset typically provides I/O and memory management functions as well as a plurality of general purpose and/or special purpose registers, timers, etc. that are accessible or used by one or more processors coupled to the chipset. The memory controller 20 performs functions that enable the processor 12 (or processors if there are multiple processors) to access a system memory 24, which may include any desired type of volatile memory such as, for example, static random access memory (SRAM), dynamic random access memory (DRAM), etc. The I/O controller 22 performs functions that enable the processor 12 to communicate with peripheral input/output (I/O) devices 26 and 28 via an I/O bus 30. The I/O devices 26 and 28 may be any desired type of I/O device such as, for example, a keyboard, a video display or monitor, a mouse, etc. While the memory controller 20 and the I/O controller 22 are depicted in FIG. 1 as separate functional blocks within the chipset 18, the functions performed by these blocks may be integrated within a single semiconductor circuit or may be implemented using two or more separate integrated circuits.

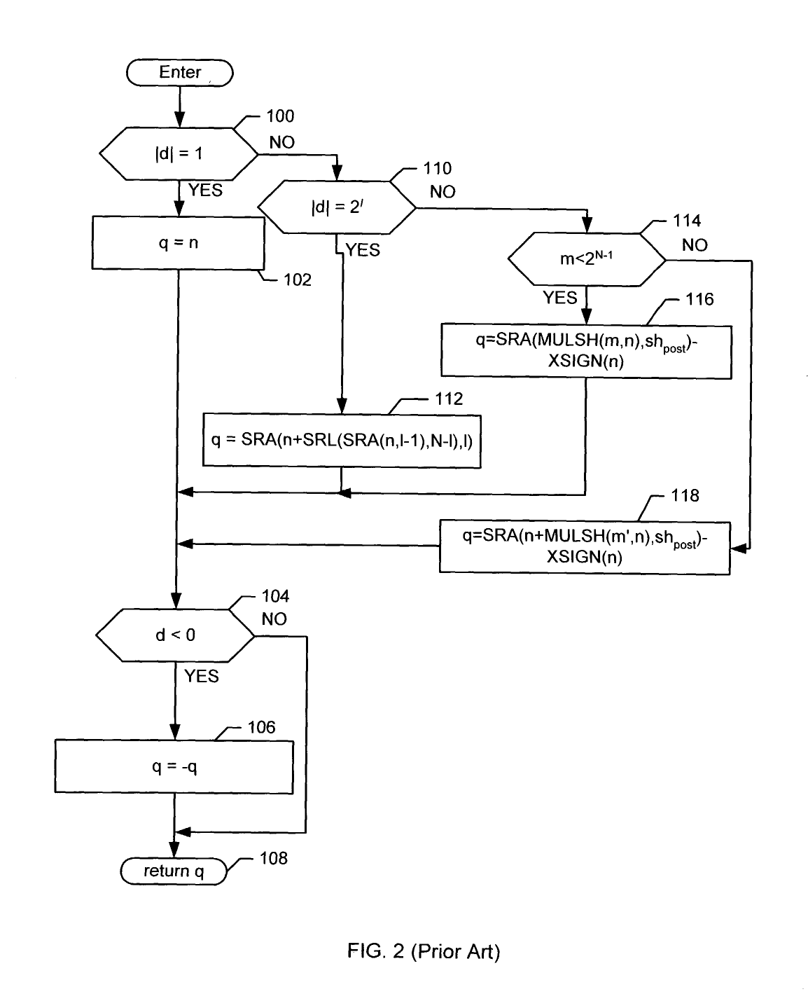

FIG. 2 is an example flow diagram that illustrates one known manner in which a signed integer long division can be carried out by the processor system 10 shown in FIG. 1. Prior to execution of the technique shown in FIG. 2 by the processor system 10 (FIG. 1), the values shown below are calculated according to Equations 1 through 5, either prior to or during compilation of the instructions used by the processor 12 to carry out the technique shown in FIG. 2.

l=max(┌log₂|d|┐, 1) Equation 1

m=1+└2^{N+l-1}/|d|┘ Equation 2

m′=m−2^{N} Equation 3

d_{sign}=XSIGN(d) Equation 4

shₚₒₛₜ=l−1 Equation 5

The values l, d_{sign} and shₚₒₛₜ are thirty-two bit signed integer values and the values m and m′ are sixty-four bit signed integer values. Additionally, the function XSIGN(x)=−1 for x<0 and 0 for x≧0.

For the purpose of providing a better understanding of the signed integer division apparatus and methods described herein, a brief explaination of each of Equations 1 through 5 is provided. The value l, which is calculated using Equation 1, is associated with the bit length of the divisor (d) in binary. In particular, in a case where the divisor (d) is equal to an integer power of two (e.g., 2, 4, 8, 16, etc.), the value l represents the number of bits trailing the most significant logical one. Thus, if the divisor (d) equals sixteen base ten (i.e., 10000 binary), the value l equals four. On the other hand, if the divisor (d) is not equal to an integer power of two, then the value l equals the number of bits trailing the most significant logical one plus one. Thus, if the divisor equals fifteen base ten (i.e., 01111 binary), the value l equals four. As can be seen in Equation 1, a ceiling function is used to round the result of log₂|d| to the next highest integer.

The values m and m′, which are calculated using Equations 2 and 3, respectively, are integer values associated with the reciprocal of the divisor (d). As a result, multiplying the values m or m′ by the dividend (n) yields a value associated with the quotient (q). The value d_{sign}, which is calculated using Equation 4, is used to hold the sign of the divisor (d). The value shₚₒₛₜ which is calculated using Equation 5, is used to perform an arithmetic shift on the results of a MULSH function as described in greater detail below. The Equations 1 through 5 above, as well as the technique described in connection with FIG. 2 below, are based on the use of two's complement arithmetic within a processor or processor system.

In the event the processor 12 is required to perform a long division operation involving a sixty-four bit signed integer dividend (n) and a sixty-four bit signed integer divisor (d), the processor 12 performs the operations detailed in FIG. 2 to calculate a signed integer quotient (q) that is rounded towards zero. As shown in FIG. 2, the processor 12 first determines if the magnitude of the divisor (d) is equal to one (block 100). If the magnitude of the divisor (d) is equal to one, the processor 12 sets the quotient (q) equal to the dividend (n) (block 102) and then determines if the divisor (d) is less than zero (block 104). If the divisor (d) is less than zero, the processor 12 negates the quotient (q) (block 106) and returns the quotient (q) (block 108) to the process or routine that called for execution of the long division. The negation of the quotient (q) (block 106) is performed according to Equation 6 below.

q=EOR(q, d_{sign})−d_{sign} Equation 6

In equation 6 above, the function EOR(q, d_{sign}) performs a bitwise exclusive OR of q and d_{sign}. If the processor 12 determines that the divisor (d) is not less than zero (i.e., is greater than or equal to zero) (block 104), then the processor 12 returns the quotient (q) (block 108) without first negating the quotient (q) (block 106).

On the other hand, if the processor 12 determines that the magnitude of the divisor (d) is not equal to one (block 100), then the processor 12 determines if the magnitude of the divisor (d) equals 2^{l}. If the processor 12 determines that the magnitude of the divisor (d) equals 2^{l} (block 110), then the processor 12 calculates the quotient (q) according to Equation 7 below (block 112).

q=SRA(n+SRL(SRA(n, l−1), N−l), l) Equation 7

The function SRA(x, y) used in Equation 7 above performs an arithmetic shift right of x by y bits. The function SRL(x, y) performs a logical shift right of x by y bits. The processor 12 then determines if the divisor (d) if less than zero (block 104), negates the quotient (q) (block 106) if the divisor is less than zero and returns the quotient (q) (block 108) to the routine that called for the long division.

If the processor 12 determines that the magnitude of the divisor (d) is not equal to 2^{l} (block 110), then the processor 12 determines if the value m is less than 2^{N-1} (block 114). The comparison made in block 114 enables the processor to use either the value m or m′ for calculation of the quotient (q) to prevent an undesireable overflow during calculation of the quotient (q). If the processor 12 determines that m is less than 2^{N-1}, then the processor 12 calculates the quotient (q) according to Equation 8 below (block 116).

q=SRA(MULSH(m, n), shₚₒₛₜ)−XSIGN(n) Equation 8

The function MULSH(x, y) returns the upper half (i.e., the upper sixty-four bits) of the signed product of x and y, which is a one hundred twenty-eight bit value.

If the processor 12 determines that m is not less than (i.e., is greater than or equal to)2^{N-1} (block 114), then the processor 12 calculates the quotient (q) according to Equation 9 below (block 118).

q=SRA(n+MULSH(m′, n), shₚₒₛₜ)−XSIGN(n) Equation 9

After calculating the quotient (q) according to either Equation 8 or Equation 9, the processor 12 determines if the divisor (d) is less than zero (block 104), negates the quotient (q) if the divisor (d) is less than zero (block 106), and returns the quotient (q) (block 108) to the routine that called for the long division.

While the example long division technique shown in FIG. 2 enables division of a sixty-four bit dividend by a run-time invariant or predetermined (i.e., known before run-time) sixty-four bit signed integer divisor to be performed using multiplications during run-time, the technique nevertheless results in a substantial amount of processing overhead. In particular, the result of MULSH(x, y), which is a signed one hundred twenty-eight bit product, is typically calculated by splitting each of the operands x and y into two thirty-two bit halves and then calculating the result according to Equation 10 below. Specifically, the operand x is split into x(u), which is the upper thirty-two bits of x, and x(l), which is the lower thirty-two bits of x. Similarly, the operand y is split into y(u) and y(l), representing the upper and lower thirty-two bit portions of y, respectively.

x*y=x(u)*y(u)*2⁶⁴+(x(u)*y(l)+x(l)*y(u))*2³²+x(l)*y(l) Equation 10

Thus, the function MULSH(x, y) is performed by calculating the result of Equation 10 above and then truncating the one hundred twenty-eight bit result to return the upper sixty-four bits of the result of Equation 10. However, because the operands x and y may have different signs (i.e., one operand is positive and the other is negative), it is usually necessary to store the signs of the operands x and y, calculate Equation 10 using the absolute values of x andy and then negate the result (i.e., the one hundred twenty-eight bit product) of Equation 10 if x and y have different signs.

In practice, the value m′ is often negative and the value n (i.e., the dividend) is often positive. As a result, performance of the function MULSH(m′, n) requires frequent negation of a one hundred twenty-eight bit product. Generation of the absolute values of m′ and n in combination with the frequent negations of the one hundred twenty-eight bit product of Equation 10, produces a substantial amount of processing overhead that results in a relatively slow long division process. As a result, for many software applications that require repetitive long divisions involving run-time invariant divisors (e.g., Java applications, benchmarks, etc.), the technique shown and described in connection with FIG. 2 above may fail to provide sufficient processor throughput.

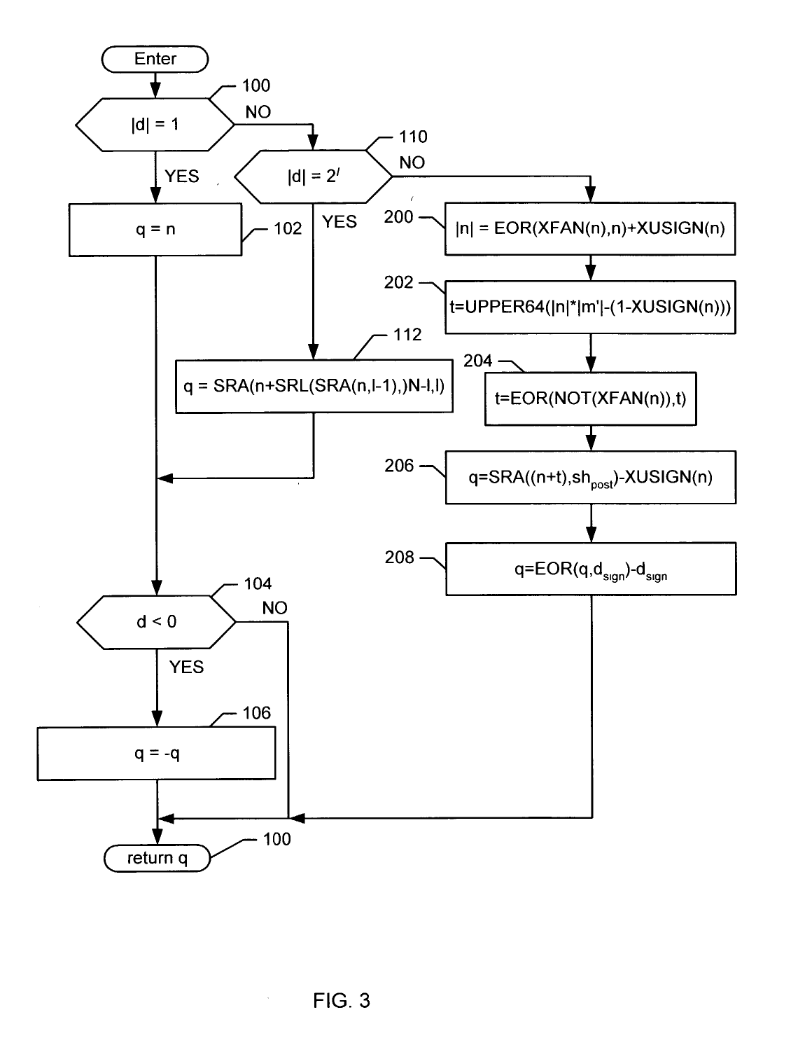

FIG. 3 is an example flow diagram of another manner in which a signed integer long division can be carried out by the processor system 10 of FIG. 1. As shown in FIG. 3, in the case where the magnitude of the divisor (d) is equal to one or 2^{l}, the quotient (q) is calculated in an identical manner to that shown and described in connection with blocks 102-106 and block 112 FIG. 2 above. However, in the case where the magnitude of the divisor (d) is not equal to one and is not equal to 2^{l}, the quotient (q) is calculated according to blocks 200 through 208 shown and described in connection with FIG. 3. In particular, the processor 12 calculates the absolute value of the dividend (n) using Equation 11 below (block 200).

|n|=EOR(XFAN(n), n)+XUSIGN(n) Equation 11

The function EOR is a bitwise exclusive OR as defined above, and the functions XFAN(n) and XUSIGN(N) are defined in Equations 12 and 13 below.

XFAN(n)=0 if n≧0; and XFAN(n)=2^{N}−1 if n<0 Equation 12

XUSIGN(n)=1 if n<0; and XUSIGN(n)=0 if n≧0 Equation 13

After calculating the absolute value of the dividend (n), the processor 12 calculates the upper sixty-four bits of the product of the absolute value of the dividend (n) and the absolute value of m′ according to Equations 14 and 15 below (blocks 202 and 204).

t=UPPER64(|n|*|m′|−(1−XUSIGN(n)) Equation 14

t=EOR(NOT(XFAN(n)), t) Equation 15

Equations 14 and 15 are calculated in sequence (i.e., Equation 14 first followed by Equation 15) and result in the value “t,” which is equivalent to the result of the function MULSH(m′, n) (i.e., t=MULSH(m′, n)). The NOT(x) function performs a bitwise NOT operation such that each logical 1 is cleared to zero and each logical zero is set to 1. The UPPER64(x) function truncates x to return the upper sixty-four bits of x. However, as can be seen from Equations 14 and 15 above, because the absolute values of n and m′ are multiplied, it is not necessary to perform the multiplication using four separate multiplications followed by negation of a one hundred twenty-eight bit product, as is often the case when calculating the product of n and m′ using the MULSH function. Additionally, calculating the upper sixty-four bits of the product of n and m′ using Equations 14 and 15 above eliminates the need to determine if m<2^{N-1} as is shown in block 114 of FIG. 2. Still further, because Equation 14 eliminates the lower sixty-four bits of the product of the absolute values of n and m′ relatively early in the calculation process, less temporary memory, fewer registers, and fewer store and load operations are required in comparison to the technique shown in FIG. 2.

Following the calculation of “t” using Equations 14 and 15 above, the processor 12 calculates the quotient (q) according to Equation 16 below (block 206), negates the quotient (q), if necessary, according to Equation 17 below (block 208), and returns the quotient (q) to the routine or process that called for the long division.

q=SRA((n+t), shₚₒₛₜ)−XUSIGN(n) Equation 16

q=EOR(q, d_{signs})−d_{signs} Equation 17

Thus, the example technique described in connection with FIG. 3 enables a processor, processor system or computer system to perform signed integer long division more efficiently (e.g., faster, using fewer operations, using less memory and/or registers, etc.) than was possible with known techniques, such as the technique shown and described in connection with FIG. 2. In particular, the example technique shown in FIG. 3 eliminates the need to perform a relatively large number of multiplication operations, which consume a relatively large amount of temporary memory and generate a relatively large number of store and load operations, and eliminates the need to perform additional comparisons and/or conditional jumps (e.g., block 114 of FIG. 2).

More specifically, the example methods and apparatus describe in connection with FIGS. 1 and 3 herein enables a processor having an architecture and instruction set that processes operands having fewer bits than needed to represent the values upon which a long division is to be performed to more quickly perform the long division. For example, the methods and apparatus described in connection with FIGS. 1 and 3 are particularly well-suited for use by a thirty-two bit processor (e.g., an IA-32 processor), to perform long division between two sixty-four bit signed integers.

Although certain methods and apparatus have been described herein, the scope of coverage of this patent is not limited thereto. To the contrary, this patent covers all embodiments fairly falling within the scope of the appended claims either literally or under the doctrine of equivalents.

What is claimed is:

1. An apparatus for performing a long division, comprising:
a processor system including a memory; and
instructions stored in the memory to be executed by the processor system to cause the processor system to:
calculate a first value equal to an absolute value of a dividend;
multiply the first value by a second value to generate a third value, wherein the second value is an absolute value of a fourth value associated with a reciprocal of a divisor; and
calculate a quotient based on the third value.

2. The apparatus of claim 1, wherein the first through fourth values are integer values, and wherein the dividend, the divisor and the quotient are signed integers.

3. The apparatus of claim 1, wherein the processor system includes a thirty-two bit processor to execute the instructions, and wherein the dividend, the divisor and the quotient are sixty-four bit signed integers.

4. The apparatus of claim 1, wherein the instructions stored in the memory are executed by the processor system to cause the processor system to calculate the first value by performing a bitwise exclusive OR operation of the dividend and a fifth value to produce a sixth value, wherein the fifth value equals two raised to a number of bits associated with the dividend minus one if the dividend is less than zero and zero if the dividend is greater than or equal to zero.

5. The apparatus of claim 4, wherein the instructions stored in the memory are executed by the processor system to cause the processor system to calculate the first value by adding one to the sixth value if the dividend is less than zero.

6. The apparatus of claim 1, wherein the instructions stored in the memory are executed by the processor system to cause the processor system to generate a fifth value by subtracting one from the third value prior to calculating the quotient if the dividend is greater than or equal to zero.

7. The apparatus of claim 6, wherein the instructions stored in the memory are executed by the processor system to cause the processor system to eliminate a set of bits from the fifth value to generate a sixth value.

8. The apparatus of claim 7, wherein the instructions stored in the memory are executed by the processor system to cause the processor system to perform a bitwise exclusive OR of a seventh value and the sixth value to generate an eighth value, wherein the seventh value equals the logical inversion of a ninth value.

9. The apparatus of claim 8, wherein the ninth value equals two raised to the number of bits associated with the dividend minus one if the dividend is less than zero and wherein the ninth value equals zero if the dividend is greater than or equal to zero.

10. The apparatus of claim 8, wherein the instructions stored in the memory are executed by the processor system to cause the processor system to calculate the quotient based on the ninth value.

11. A system for performing a long division, comprising:
a computer readable medium; and
instructions stored on the computer readable medium and adapted to be executed by a processor to:
calculate a first value associated with an absolute value of a dividend;
multiply the first value by a second value to generate a third value, wherein the second value is an absolute value of a fourth value associated with a reciprocal of a divisor; and
calculate a quotient based on the third value.

12. The system of claim 10, wherein the instructions stored in the memory are adapted to be executed by the processor to calculate the first value by performing a bitwise exclusive OR of the dividend and a fifth value to produce a sixth value, wherein the fifth value equals two raised to a number of bits associated with the dividend minus one if the dividend is less than zero and zero if the dividend is greater than or equal to zero.

13. The system of claim 11, wherein the instructions stored in the memory are adapted to be executed by the processor to calculate the first value by adding one to the sixth value if the dividend is less than zero.

14. The system of claim 11, wherein the instructions stored in the memory are adapted to be executed by the processor to generate a fifth value by subtracting one from the third value prior to calculating the quotient if the dividend is greater than or equal to zero.

15. The system of claim 14, wherein the instructions stored in the memory are adapted to be executed by the processor to eliminate a set bits from the fifth value to generate a sixth value.

16. The system of claim 15, wherein the instructions stored in the memory are adapted to be executed by the processor to perform a bitwise exclusive OR of a seventh value and the sixth value to generate an eighth value, wherein the seventh value equals the logical inversion of a ninth value.

17. The system of claim 16, wherein the ninth value equals two raised to the number of bits associated with the dividend minus one if the dividend is less than zero and wherein the ninth value equals zero if the dividend is greater than or equal to zero.

18. The system of claim 17, wherein the instructions stored in the memory are adapted to be executed by the processor to cause the processing unit to calculate the quotient based on the ninth value.

19. An apparatus for performing a signed integer division of a signed integer dividend and a signed integer divisor, comprising:
a processor;
a memory coupled to the processor; and
instructions stored on the memory and adapted to be executed by the processor to cause the processor to:
multiply a first value equal to the absolute value of the signed integer dividend by a second value to generate a third value, wherein the second value is an absolute value of a fourth value that is calculated prior to execution of the instructions stored on the memory using a reciprocal of the signed integer divisor;
subtract one from the third value to generate a fifth value if the signed integer dividend is greater than or equal to one;
truncate the fifth value to generate a sixth value;
set a seventh value equal to two to a power equal to a number of bits defining the signed integer dividend minus one if the signed integer dividend is less than zero;
set the seventh value equal to zero if the signed integer dividend is greater than or equal to zero;
perform a bitwise exclusive OR of the sixth and seventh values to generate an eighth value; and
calculate a signed integer quotient based on the eighth value.

20. The apparatus of claim 19, wherein the instructions stored on the memory are adapted to be executed by the processor to cause the processor to generate the first value by performing a bitwise exclusive OR of the signed integer dividend and a ninth value, wherein the ninth value is set equal to two to a power equal to a number of bits defining the signed integer dividend minus one if the signed integer dividend is less than zero and is set to zero if the signed integer dividend is greater than or equal to zero.

21. The apparatus of claim 19, wherein the signed integer divisor, the signed integer dividend and the signed integer quotient are represented by sixty-four bit binary values, and wherein the processor has a thirty-two bit architecture.

22. The apparatus of claim 19, wherein the signed integer divisor is invariant during a run-time of the processor.

23. The apparatus of claim 19, wherein the instructions stored on the memory are executed by the processor in response to a request by an application to perform a signed integer long division.

24. The apparatus of claim 23, wherein the application is a Java-based application.

25. A system for performing a signed integer division of a signed integer dividend and a signed integer divisor, comprising:
a computer readable medium; and
instructions stored on the computer readable medium and adapted to be executed by a processor to:
multiply a first value equal to the absolute value of the signed integer dividend by a second value to generate a third value, wherein the second value is an absolute value of a fourth value that is calculated prior to execution of the instructions stored on the memory using a reciprocal of the signed integer divisor;
subtract one from the third value to generate a fifth value if the signed integer dividend is greater than or equal to one;
truncate the fifth value to generate a sixth value;
set a seventh value equal to two to a power equal to a number of bits defining the signed integer dividend minus one if the signed integer dividend is less than zero;
set the seventh value equal to zero if the signed integer dividend is greater than or equal to zero;
perform a bitwise exclusive OR of the sixth and seventh values to generate an eighth value; and
calculate a signed integer quotient based on the eighth value.

26. The system of claim 25, wherein the instructions stored on the computer readable medium are adapted to be executed by the processor to generate the first value by performing a bitwise exclusive OR of the signed integer dividend and a ninth value, wherein the ninth value is set equal to two to a power equal to a number of bits defining the signed integer dividend minus one if the signed integer dividend is less than zero and is set to zero if the signed integer dividend is greater than or equal to zero.

27. An apparatus for performing a signed integer long division, comprising:
a processor;
a memory coupled to the processor; and
instructions stored on the memory and executed by the processor to:
sum the results of an XFAN function and an XUSIGN function to generate an absolute value of a signed integer dividend;
calculate the upper sixty-four bits of the product of the signed integer dividend and a value associated with a reciprocal of a signed integer divisor based on the absolute value of the signed integer dividend, an absolute value of the value associated with the reciprocal of the signed integer divisor, an EOR function, the XFAN function, the XUSIGN function, and an UPPER64 function; and
calculate a signed integer quotient based on the upper sixty-four bits of the product of the signed integer dividend based on an SRA function, the XUSIGN function and the EOR function.

28. The apparatus of claim 27, wherein the processor has a thirty-two bit architecture.

29. The apparatus of claim 27, wherein the instructions stored on the memory are executed by the processor to calculate the upper sixty-four bits of the product of the signed integer dividend and a value associated with a reciprocal of a signed integer divisor by calculating EOR(NOT(XFAN(n)),UPPER64(n′*m″−(1−XUSIGN(n))), wherein n equals the signed integer dividend, n′ equals the absolute value of the signed integer dividend, and m” equals the absolute value of m′.

30. A method of controlling a processor to perform a signed integer long division using an invariant divisor, comprising:
executing a set of instructions in the processor in response to a request to perform a signed integer division, wherein execution of the instructions causes the processor to:
calculate the absolute value of a signed integer dividend;
multiply the absolute value of the signed integer dividend by an absolute value of a parameter associated with a reciprocal of the invariant divisor to form a truncated value equal to an upper half of the total bits of the product of the signed integer dividend and the parameter associated with the reciprocal of the invariant divisor; and
calculate a signed integer quotient based on the truncated value.

31. The method of claim 30, wherein executing the set of instructions in the processor in response to the request to perform the signed integer division includes executing the set of instructions in the processor in response to a Java-based application.

32. The method of claim 30, wherein executing the set of instructions in the processor in response to the request to perform a signed integer division to cause the processor to calculate the absolute value of the signed integer dividend includes calculating the absolute value of the signed integer dividend by setting a first value equal to two to a power equal to a number of bits associated with the signed integer dividend minus one if the signed integer dividend is less than zero and to zero if the signed integer dividend is greater than or equal to zero, performing a bitwise exclusive OR of the first value and the signed integer dividend to generate a second value and subtracting one from the second value if the signed integer dividend is less than zero.

33. The method of claim 30, wherein executing the set of instructions in the processor in response to the request to perform a signed integer division to cause the processor to multiply the absolute value of the signed integer dividend by the absolute value of the parameter associated with a reciprocal of the invariant divisor to form the truncated value includes truncating an upper sixty-four bits from a one hundred twenty-eight bit product.
